(19) United States
(12) Patent Application Publication
(10) Pub. No.: US 2023/0254130 A1
(43) Pub. Date: Aug. 10, 2023

(54) METHOD AND SYSTEM FOR MEASUREMENT-DEVICE-INDEPENDENT QUANTUM KEY DISTRIBUTION NETWORK

(71) Applicant: NATIONAL UNIVERSITY OF SINGAPORE, Singapore (SG)

(72) Inventors: Chao WANG, Singapore (SG); Ci Wen LIM, Singapore (SG); Koon Tong GOH, Singapore (SG)

(73) Assignee: NATIONAL UNIVERSITY OF SINGAPORE, Singapore (SG)

(21) Appl. No.: 18/015,611

(22) PCT Filed: Jul. 13, 2021
(86) PCT No.: PCT/SG2021/050408

§ 371 Date: Jan. 11, 2023

(30) Foreign Application Priority Data
Jul. 14, 2020 (SG) 10202006706W

(51) Int. Cl. H04L 9/08; G06F 21/56

(52) U.S. Cl. CPC H04L 9/0852; G06F 21/567

(57) ABSTRACT

A measurement-device-independent (MDI) quantum key distribution (QKD) network, a method of operating an MDI QKD network comprising a common server and a plurality of user systems, a user system for a MDI QKD network, and a method of operating a user system for a MDI QKD network. The method of operating an MDI QKD network comprising a common server and a plurality of user systems comprises the steps of performing optical pulse generation and distribution using a laser source at the common server; receiving the optical pulses at the user systems from the common server; modulating the optical pulses at the user systems for quantum communication; re-transmitting the modulated optical pulses from the user systems to the common server; and using an energy bounding component at each of the user system for limiting Trojan horse attack (THA).

### FIELD OF INVENTION

The present invention relates broadly to a method and system for measurement-device-independent quantum key distribution network, in particular to a measurement-device-independent (MDI) quantum key distribution (QKD) network, a method of operating an MDI QKD network comprising a common server and a plurality of user systems, a user system for a MDI QKD network, and a method of operating a user system for a MDI QKD network.

### BACKGROUND

Any mention and/or discussion of prior art throughout the specification should not be considered, in any way, as an admission that this prior art is well known or forms part of common general knowledge in the field.

Quantum key distribution (QKD) is an emerging key exchange technique whose security is guaranteed solely by quantum mechanics. Since it is based on physical principle instead of computational complexity like its classical counterparts, QKD is the only method proven to be able to provide information-theoretic security. When used with one-time-pad, it is capable of resisting against quantum computer-based attacks, which could break today's prevalent cryptosystems such as Rivest-Shamir-Adleman (RSA) and elliptic-curve cryptography ECC.

However, an eavesdropper may exploit the imperfect implementation of QKD protocol to extract information from the users. In particular, the detector is the most vulnerable component of the entire QKD setup and poses security risk to the cryptographic device.

To solve this problem, Prof. H. K. Lo et al. [Measurement-device-independent quantum key distribution (Physical Review Letters 108, 130503 (2012))] proposed the measurement-device-independent quantum key distribution (MDI QKD) protocol, which is intrinsically immune to all possible measurement-side-channel attacks and possesses a star-type network structure. Having its balance between security and practicality struck, this protocol garnered interest from academics and industries alike.

Nevertheless, the proper implementation of MDI QKD demands for stringent experimental requirement and especially so when the devices operate at high repetition rate. Particularly, there are three main technical challenges. Firstly, a precise timing control is required since short pulses from independent users are supposed to interfere at the common server, which leads to a typical timing accuracy requirement of ˜10 ps for an MDI system operating at a rate of ˜GHz. Secondly, a precise wavelength calibration is needed for high visibility optical interference, which is commonly performed by high accuracy temperature control to achieve a ˜10⁴ nm wavelength accuracy and stability. Thirdly, the independent laser pulses should be well aligned to reduce the photon receiving loss and improve the detection efficiency and stability. These precise calibration of timing, wavelength and polarization would introduce sophisticated aligning systems into the experimental setup, which may lead to additional security loopholes and overheads to the system.

Other proposed quantum key distribution systems include:

[Star-type network based on point-to-point configuration (IEEE Photonics Technology Letters 21, 575 (2009))] In this paper, the authors proposed a star-type network based on point-to-point architecture together with wavelength multiplexing assisted QKD router. However, their configuration does not possess the MDI feature and their receiver may suffer from measurement related side-channel attacks. In addition, every user has to possess both the transmitter and receiver, which significantly increase the system cost.

[Cambridge quantum network (Npj Quantum Information 5, 1 (2019))] In this paper, a three-node mesh type QKD network has been demonstrated. Here, the point-to-point QKD system architecture has also been deployed, leaving potential security vulnerabilities on the measurement devices.

Embodiments of the present invention seek to address at least one of the above problems.

### SUMMARY

In accordance with a first aspect of the present invention there is provided a measurement-device-independent (MDI) quantum key distribution (QKD) network comprising:

a common server with a laser source for optical pulse generation and distribution;
a plurality of user systems, each user system configured to:
receive the optical pulses from the common server;
modulate the optical pulses for quantum communication; and
re-transmit the modulated optical pulses to the common server;
wherein each user system comprises an energy bounding component for limiting Trojan horse attack (THA).

In accordance with a second aspect of the present invention there is provided a method of operating an MDI QKD network comprising a common server and a plurality of user systems, the method comprising the steps of:

performing optical pulse generation and distribution using a laser source at the common server;
receiving the optical pulses at the user systems from the common server;
modulating the optical pulses at the user systems for quantum communication;
re-transmitting the modulated optical pulses from the user systems to the common server; and
and using an energy bounding component at each of the user system for limiting Trojan horse attack (THA).

In accordance with a third aspect of the present invention there is provided a user system for a measurement-device-independent (MDI) quantum key distribution (QKD) network comprising:

a receiver configured to receive optical pulses generated and distributed by a common server;
a modulator configured to modulate the optical pulses for quantum communication;
a transmitter configured to re-transmit the modulated optical pulses to the common server; and
an energy bounding component for limiting Trojan horse attack (THA).

In accordance with a fourth aspect of the present invention there is provided a method of operating a user system for a measurement-device-independent (MDI) quantum key distribution (QKD) network comprising the steps of:

receiving, at the user system, optical pulses generated and distributed by a common server;
modulating, at the user system, the optical pulses for quantum communication;
re-transmitting, at the user system, the modulated optical pulses to the common server; and
performing energy bounding, at the user system, for limiting Trojan horse attack (THA).

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram illustrating a MDI QKD network according to an example embodiments.

FIG. 2 shows a schematic diagram illustrating a MDI QKD network according to an example embodiments.

FIG. 3 shows a flowchart illustrating a method of operating an MDI QKD network comprising a common server and a plurality of user systems, according to an example embodiment.

FIG. 4 shows a flowchart illustrating a method of operating a user system for a MDI QKD network, according to an example embodiment.

### DETAILED DESCRIPTION

Embodiments of the present invention provide a method and system design for a measurement-device-independent (MDI) quantum key distribution (QKD) network with a reciprocating star-type architecture. In example embodiments, the common server works as both the transmitter and receiver, which need not to be trusted. The users will perform modulations on the received light carrier and send it back to the server for measurement. In this way, the stringent requirement for system calibration can be largely relieved. Moreover, side-channel attacks on the users, in particular the Trojan Horse Attack, have been taken into consideration in embodiments of the present invention for a secure, robust and cost-effective MDI QKD network.

The method and system design for MDI QKD network with an untrusted server according to example embodiments can largely reduce the technical requirements for the practical implementation of an MDI QKD system and its network deployment. Specifically, by using a common laser source and quantum state measurement devices according to example embodiments, the above-mentioned requirements for precise controls of timing, wavelength, as well as polarization can advantageously be removed.

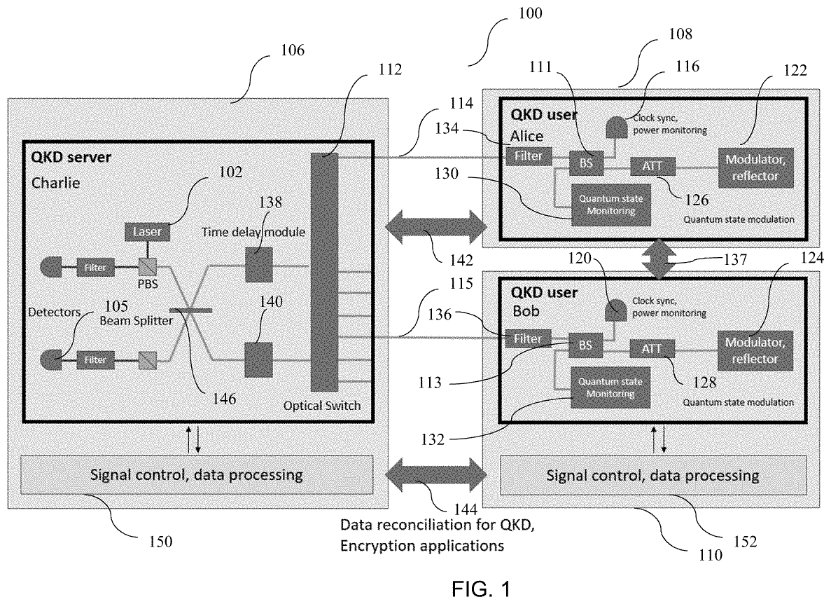

The schematic of a plug-and-play MDI QKD system 100 according to an example embodiments is shown in FIG. 1. In the system 100, the laser 102 and photon detectors e.g. 104 are both located in the common server 106 named Charlie and they act as the source and measurement of the quantum state, respectively. Moreover, the common server 106 of Charlie could be malicious and is untrusted. Charlie will prepare and distribute a laser pulse string to authenticated user systems e.g. 108, 110 named Alice and Bob, respectively, by an optical switch 112 and optical fibres e.g. 114, 115. In this example embodiment, laser 102 is a pulsed laser source. However, a continuous-wave laser together with an intensity modulator may be used in a different example embodiment, for optical pulse generation and distribution. The signal modulation for quantum communication is done at user systems Alice and Bob.

It has been recognized by the inventors that for plug-and-play MDI QKD systems the amount of information leakage via THA has a positive relationship with the intensity of the light re-transmitted from e.g. Alice and Bob to Charlie. More specifically, an eavesdropper may inject a strong light pulse between Alice/Bob and Charlie and collect a certain fraction of the reflected signal which now contains the modulation information from e.g. Alice and Bob. In embodiments of the present invention, by limiting the light power re-transmitted by Alice and Bob to Charlie, the amount of leaked information in the plug and play MDI QKD system 100 can advantageously be upper bound.

Specifically, photon energy bounding is performed with photon number distribution monitoring, for limiting the Trojan-horse attack (THA), in the plug-and-play MDI-QKD 100 according to one example embodiment. After receiving the pulse string, the users e.g. 108, 110 will first make use of some portion of its power, via beam splitter (BS) 111, 113, for system clock synchronisation, indicated at numerals 116, 120. The remaining pulse light will have its intensity and phase modulated, indicated at numerals 122, 124 and reflected back into the incoming fibre e.g. 114, 115. It is noted that after transmitting through the optical attenuator (ATT) 126, 128, the encoded quantum state will be characterised by a photon distribution monitoring apparatus 130, 132 for energy bounding. If it fulfils the prescribed security requirement, the quantum states will be spectrum filtered, indicated at numeral 134, 136, and be transmitted back to the common server 106. On the other hand, if the security requirement is not fulfilled, although the modulated signal will still be sent to the common server 106 and be measured by the detectors e.g. 104, Alice and Bob will discard the measurement results (“unsuccessful events”) and do not generate keys for secure communication and only use the measurements results for which the security result was fulfilled at both Alice and Bob (“successful events”), as communicated via the communication link 137 between Alice and Bob. Thus, any unbound re-transmission from Alice/Bob to the common server does not affect the security of the plug-and-play MDI QKD system 100.

As mentioned above, a Trojan-horse attack is a practical attack in which the adversary strategically injects a strong light pulse into the transmitter of a QKD system and retrieves some information about the modulation pattern from the back-reflected light pulse. Since the modulation pattern contains information about the secret keys, the adversary could learn some information about the keys without introducing any noise into the quantum channel.

It has been recognized by the inventors that in a plug-and-play MDI QKD system, the light from the common server to the user systems Alice/Bob gets reflected and modulated and then re-transmitted into the common server via the quantum channel, and hence THA can be easily implemented by the adversary in such plug-and-play MDI QKD.

To tackle this security issue, the inventors have recognized that the THA can be treated as an information leakage problem [1, 2]. Briefly, if one models the Trojan horse light as coherent state with fixed intensity, it can be shown that the higher the intensity of the back-reflected light from Alice/Bob, the higher the probability for an eavesdropper to correctly guess the modulation information sent back to Charlie. This leads to a higher amount of information leakage, resulting in lower secret key rate of the system. Thus, it has been recognized by the inventors that by bounding the photon energy sent back to Charlie, one can limit the information leaked to eavesdropper and preferably guarantee an acceptable key rate of the system.

Hence, embodiments of the present invention advantageously provide a complete plug-and-play MDI-QKD system with energy-bounding-based countermeasure to limit the THA. The energy bounding can be achieved differently according to various example embodiments.

In the example embodiment shown in FIG. 1 with a photon number distribution monitoring 103, 132, for example a homodyne detector together with a phase-randomized local oscillator can be used to implement the energy bounding. It is noted that according to example embodiments, the requirement for wavelength calibration is much lower than the requirement for wavelength calibration between users in existing MDI QKD. For an ideal homodyne detector, its measurement operator can be presented as:

$$Π ( q ) = {\int }_{0}^{2 π} \frac{d φ}{2 π} \vert q ( φ ) 〉 〈 q ( φ ) \vert = {\sum }_{k} {ϕ}_{k} ( q ) \vert k 〉 〈 k \vert {ϕ}_{k}^{*} ( q ) \qquad ( 1 )$$

where ϕₖ(q) is the wave function of the photon number state |n [symbol] in coordinate representation

$${ϕ}_{k} ( q ) = {e}^{ik φ} \frac{1}{\sqrt{{2}^{k} k !}} {H}_{n} ( q ) {( \frac{1}{π} )}^{1 / 4} {e}^{- \frac{{q}^{2}}{2}}$$

and Hₙ(q) are the Hermite polynomials.

The measurement result of an unknown quantum state p can be presented as

M=Tr(ρ·Π(q)) (2)

Thus, with the measurement results and linear programming (detector decoy method), one can obtain the measurement results given by specific photon number states, which gives the photon number distribution of the quantum state ρ. In this way, the photon energy of the output signal can be bounded, which in turn limits the THA. As mentioned above, if the security requirement, i.e. energy bounding requirement, is not fulfilled, although the modulated signal will still be sent to the common server 106 and measured by the detectors e.g. 104, Alice and Bob will discard the measurement results and do not generate keys for secure communication, as communicated via the communication link 137 between Alice and Bob. Thus, any unbound re-transmission from Alice/Bob to the common server does not affect the security of the plug-and-play MDI QKD system 100.

In the common server 106, the returning signal states possess a polarisation that is orthogonal to that of the signal states that are being sent out by the server 106 due to the reflection of light signal from the common server 106 at Alice at Bob. Thus, identical polarisation states from independent users can be always guaranteed. For example, a Faraday Mirror or another structure having equivalent property can be used in modulator/reflectors 122, 124, which will rotate the polarization of the input state by 90 degrees, no matter what the evaluation details of the connected fibre is. Thus, the photons being reflected back from Alice and Bob preferably will have the same state of polarization, which is 90 degree compared to the polarization of the photon sent out from the common server 106.

The signal pulses from the users will go through the optical switch 112 and the time delay module e.g. 138, 140 for timing calibration. The possible backscattering caused by optical components and the fibre channel can be further reduced by fine tuning the time delay, proper spectrum filtering, and gating the photon detectors, according to various example embodiment.

Specifically, the main source of back reflection may include three parts:

1. Rayleigh backscattering of the optical fibre.
2. Raman backscattering of the optical fibre.
3. Backscattering of the optical components.

For the Rayleigh backscattering, it happens continuously in the time domain, so one can apply a narrow gating of the photon detector e.g. 104 to reduce its influence.

As for the Raman backscattering, it happens continuously in both the time domain and frequency domain. Thus, one can apply spectrum filtering and time filtering of the photon detector e.g. 104 gating to decrease the influence of the Raman scattering.

For the backscattering of the optical components, it will have a specific arriving time. Thus, one can fine tune the time delay (compare time delay modules e.g. 138, 140) to separate the quantum signal from Alice and Bob from these backscattering noises, to further improve the signal to noise ratio of the system.

The signals from Alice and Bob are “mixed” in the beam splitter 146 located within the server 106, so each detector 104 and 105 measures the joint signal of Alice and Bob. After the optical operations, the post-processing is done via classical communication channels e.g. 142, 144. Particularly, Charlie will notify both users about the measurement results after every round of measurement. Alice and Bob then keep only the data that corresponds to the successful events and discard the remaining data (i.e. unsuccessful events) to obtain the raw key Subsequently, Alice and Bob will perform error correction and privacy amplification to obtain a pair of fully correlated and private secret keys, as is understood by a person skilled in the art.

It is noted that while signal processing elements 150, 152, e.g. FPGAs, for control and data processing are only shown for Charlie and Bob in FIG. 1, they are also present at Alice and but have been omitted in the schematic drawing for reduced complexity.

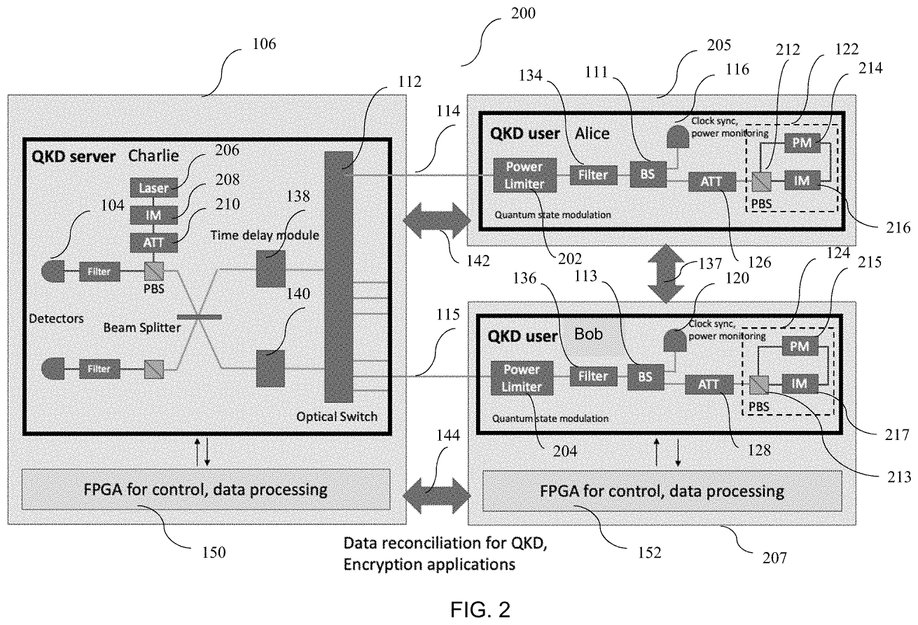

In an alternative embodiment, a passive power limiter may be used at the user systems Alice/Bob, in a modified plug-and-play system 200 shown in FIG. 2, and hence the maximum input power is limited. Thus the maximum intensity of the reflected/re-transmitted light from Alice/Bob to Charlie can also be bounded, to limit THA. The same numerals have been used for corresponding elements between the plug-and-play system 100 of FIG. 1 and the plug-and-play system 200 in FIG. 2, and those elements will not be described again here. Notably, in the plug-and-play MDI QKD system 200, power limiters 202, 204, which are bi-directional in this example embodiment, are used at the user systems 205, 207 (Alice and Bob). Various techniques/devices may be used to implement the power limiters 202, 204, such as, but not limited to, techniques and devices described in [Fiber-optical power limiter based on liquid core optical fiber (IEEE Photonics Technology Letters 24, 297-299, (2011))], [Fiber-optical power limiter based on optical adhesive (Applied Optics 40, 6611 (2001))], [Optical power limiter based on photonic chip micro-ring resonator (Scientific Reports 4, 6676, (2014))], and devices in which power limiting is achieved using an effective medium having a thermo-optic coefficient such that a light beam entering the effective medium from an input port experiences a refractive index gradient in a direction perpendicular to a propagation direction in the effective medium as a result of absorption and a diaphragm is disposed in a path of the light beam for limiting how much of the light beam reaches the output port. It is noted that since the interior of the devices 205, 207 is trusted, it can be assumed that incident bright light will never originate from the interior of the devices 205, 207. Hence, a uni-directional power limiter may be used in an example embodiment for limiting (only) the input optical power into the devices 205, 207, i.e. bright light that originates external to the transmitter.

In the example embodiment shown in FIG. 2, a continuous-wave laser 206 together with an intensity modulator 208 and attenuator 210 is used for optical pulse generation and distribution. alternatively, a pulsed laser source may be used. Also, in the embodiment shown in FIG. 2, the modulator/reflectors 122, 124 are implemented as a structure formed by a prism beam splitter (PBS) 212, 213 with a “loop optical path” including phase modulator (PM) 214, 215 and intensity modulator (IM) 216, 217 for quantum modulation with an equivalent property to a Faraday Mirror for the reflection and quantum modulation.

It is noted again that while signal processing elements 150, 152, e.g. FPGAs, for control and data processing are only shown for Charlie and Bob in FIG. 2, they are also present at Alice and but have been omitted in the schematic drawing for reduced complexity. In the embodiment in FIG. 2, compared to the embodiment in FIG. 1 described above, all measurement results received from Charlie will be used by Alice and Bob.

By eliminating the bottleneck that is common to existing plug-and-play MDI QKD implementations, i.e. the difficulties for the system calibration for central wavelength, timing, and the polarization among users, and the side-channel attacks (THA), embodiments of the present invention can pave the way for a highly secure and cost-effective QKD network by applying the plug-and-play two-way (i.e. the light will be transmitted forward to and back from the users twice in the same channel) MDI QKD system together with optical power bounding techniques.

In one embodiment, a measurement-device-independent (MDI) quantum key distribution (QKD) network is provided comprising a common server with a laser source for optical pulse generation and distribution; a plurality of user systems, each user system configured to receive the optical pulses from the common server; to modulate the optical pulses for quantum communication; and to re-transmit the modulated optical pulses to the common server; wherein each user system comprises an energy bounding component for limiting Trojan horse attack (THA).

The energy bounding component may comprise a photon number distribution monitoring system, and the plurality of user systems may be configured to communicate with each other for discarding measurement results when the photon number distribution monitoring system determines a non-fulfilment of a bound energy requirement.

The energy bounding component may comprise a power limiter for limiting the energy of the re-transmitted modulated optical pulses.

The common server may comprise one or more detectors for generating measurement results from the re-transmitted modulated optical pulses from a pair of user systems.

The common server may comprise one or more time delay modules for timing calibration of the re-transmitted modulated optical pulses from the pair of user systems.

The MDI QKD network may comprise a classical communication channel between the common server and each of the user systems for communicating the measurement results.

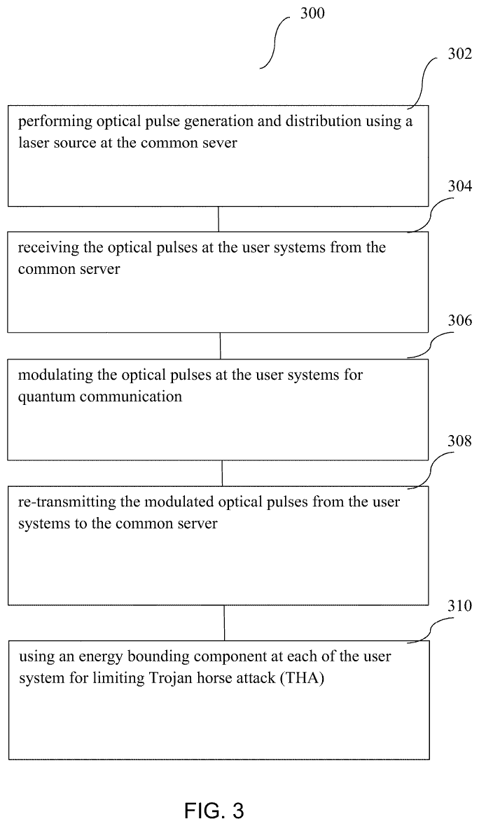

FIG. 3 shows a flowchart 300 illustrating a method of operating an MDI QKD network comprising a common server and a plurality of user systems, according to an example embodiment. At step 302, optical pulse generation and distribution is performed using a laser source at the common server. At step 304, the optical pulses are received at the user systems from the common server. At step 306, the optical pulses are modulated at the user systems for quantum communication. At step 308, the modulated optical pulses are re-transmitted from the user systems to the common server. At step 310, an energy bounding component is used at each of the user system for limiting Trojan horse attack (THA).

The energy bounding component may comprise a photon number distribution monitoring system, and the method may comprise communicating between the user systems for discarding measurement results when a non-fulfilment of a bound energy requirement is determined using the photon number distribution monitoring system.

The energy bounding component may comprise a power limiter, and the method may comprise limiting the energy of the re-transmitted modulated optical pulses using the power limiter.

The method may comprise generating measurement results from the re-transmitted modulated optical pulses from a pair of user systems received at the common server.

The method may comprise using one or more time delay modules for timing calibration of the re-transmitted modulated optical pulses from the pair of user systems at the common server.

The method may comprise using a classical communication channel between the common server and each of the user systems for communicating the measurement results.

In one embodiment, a user system for a measurement-device-independent (MDI) quantum key distribution (QKD) network is provided, comprising a receiver configured to receive optical pulses generated and distributed by a common server; a modulator configured to modulate the optical pulses for quantum communication; a transmitter configured to re-transmit the modulated optical pulses to the common server; and an energy bounding component for limiting Trojan horse attack (THA).

The energy bounding component may comprise a photon number distribution monitoring system, and the user system may be configured to communicate with another user system of the MDI QKD network for discarding measurement results when the photon number distribution monitoring system determines a non-fulfilment of a bound energy requirement.

The energy bounding component may comprise a power limiter for limiting the energy of the re-transmitted modulated optical pulses.

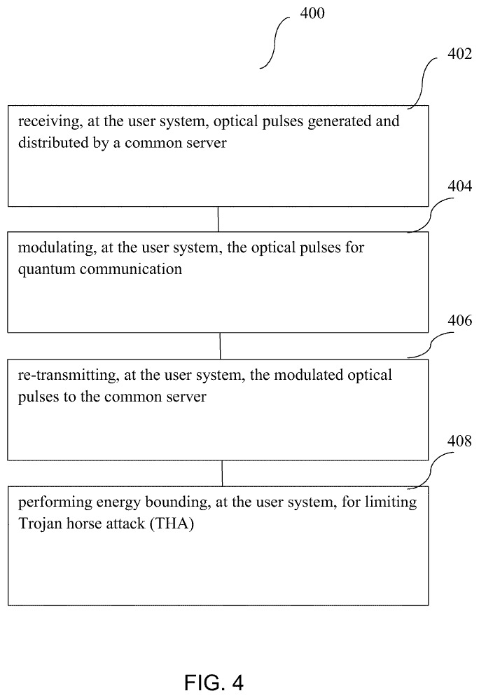

FIG. 4 shows a flowchart 400 illustrating a method of operating a user system for a measurement-device-independent (MDI) quantum key distribution (QKD) network, according to an example embodiment. At step 402, optical pulses generated and distributed by a common server are received at the user system. At step 404, the optical pulses are modulated, at the user system, for quantum communication. At step 406, the modulated optical pulses are re-transmitted, at the user system, to the common server. At step 408, energy bounding is performed, at the user system, for limiting Trojan horse attack (THA).

Performing the energy bounding may comprise using a photon number distribution monitoring system, and the method may comprise communicating between user systems for discarding measurement results when the photon number distribution monitoring system determines a non-fulfilment of a bound energy requirement.

Performing the energy bounding may comprise using a power limiter for limiting the energy of the re-transmitted modulated optical pulses.

Embodiments of the present invention can have one or more of the following features and associated benefits/advantages:

| Feature | Benefit/Advantage |
|---|---|
| Star-type network with | In example embodiments, a network |
| untrusted server | structure is provided where the untrusted |
| | server is responsible for light source |
| | distribution and quantum signal |
| | measurement. This largely decrease the |
| | network complicity and cost comparing to |
| | conventional point to point QKD |
| | configurations. |
| Simple and robust | By adopting a reciprocating architecture, |
| system architecture | example embodiments largely relieve the |
| | stringent requirements for system calibration |
| | in terms of central wavelength, timing and |
| | polarization. |
| Higher security | With the measurement-device-independent |
| | configuration, example embodiments are |
| | intrinsically immune to all side-channel |
| | attacks on the measurement devices. |
| | Moreover, by deploying photon energy |
| | bounding with photon number distribution |
| | monitoring, example embodiments can |
| | provide a reliable way for limiting the |
| | Trojan-horse attack. |

### INDUSTRIAL APPLICATIONS OF EXAMPLE EMBODIMENTS

Embodiments of the present invention fin application as method and system for MDI QKD network for providing a simple, robust and cost-effective way for constructing quantum secure communication networks.

The various functions or processes disclosed herein, such as controlling the QKD server equipment and the QKD user equipment, may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

### REFERENCES

[1] M. Lucamarini, I. Choi, M. B. Ward, J. F. Dynes, Z. L. Yuan, and A. J. Shields, Phys. Rev. X 5, 031030 (2015).
[2] I. W. Primaatmaja, E. Lavie, K. T. Goh, C. Wang, and C. C. W. Lim, Phys. Rev. A 99, 062332 (2019)

1. A measurement-device-independent (MDI) quantum key distribution (QKD) network comprising:
a common server with a laser source for optical pulse generation and distribution;
a plurality of user systems, each user system configured to:
receive the optical pulses from the common server;
modulate the optical pulses for quantum communication; and
re-transmit the modulated optical pulses to the common server;
wherein each user system comprises an energy bounding component for limiting Trojan horse attack (THA).

2. The MDI QKD network of claim 1, wherein the energy bounding component comprises a photon number distribution monitoring system, and the plurality of user systems are configured to communicate with each other for discarding measurement results when the photon number distribution monitoring system determines a non-fulfilment of a bound energy requirement.

3. The MDI QKD network of claim 1, wherein the energy bounding component comprises a power limiter for limiting the energy of the re-transmitted modulated optical pulses.

4. The MDI QKD network of claim 1, wherein the common server comprises one or more detectors for generating measurement results from the re-transmitted modulated optical pulses from a pair of user systems.

5. The MDI QKD network of claim 4, wherein the common server comprises one or more time delay modules for timing calibration of the re-transmitted modulated optical pulses from the pair of user systems.

6. The MDI QKD network of claim 4, comprising a classical communication channel between the common server and each of the user systems for communicating the measurement results.

7. A method of operating an MDI QKD network comprising a common server and a plurality of user systems, the method comprising the steps of:
performing optical pulse generation and distribution using a laser source at the common server;
receiving the optical pulses at the user systems from the common server;
modulating the optical pulses at the user systems for quantum communication;
re-transmitting the modulated optical pulses from the user systems to the common server; and
using an energy bounding component at each of the user system for limiting Trojan horse attack (THA).

8. The method of claim 7, wherein the energy bounding component comprises a photon number distribution monitoring system, and the method comprises communicating between the user systems for discarding measurement results when a non-fulfilment of a bound energy requirement is determined using the photon number distribution monitoring system.

9. The method of claim 7, wherein the energy bounding component comprises a power limiter, and the method comprises limiting the energy of the re-transmitted modulated optical pulses using the power limiter.

10. The method of claim 7, comprising generating measurement results from the re-transmitted modulated optical pulses from a pair of user systems received at the common server.

11. The method of claim 10, comprising using one or more time delay modules for timing calibration of the re-transmitted modulated optical pulses from the pair of user systems at the common server.

12. The method of claim 10, comprising using a classical communication channel between the common server and each of the user systems for communicating the measurement results.

13. A user system for a measurement-device-independent (MDI) quantum key distribution (QKD) network comprising:
a receiver configured to receive optical pulses generated and distributed by a common server;
a modulator configured to modulate the optical pulses for quantum communication;
a transmitter configured to re-transmit the modulated optical pulses to the common server; and
an energy bounding component for limiting Trojan horse attack (THA).

14. The user system of claim 13, wherein the energy bounding component comprises a photon number distribution monitoring system, and the user system is configured to communicate with another user system of the MDI QKD network for discarding measurement results when the photon number distribution monitoring system determines a non-fulfilment of a bound energy requirement.

15. The user system of claim 13, wherein the energy bounding component comprises a power limiter for limiting the energy of the re-transmitted modulated optical pulses.

16. A method of operating the user system for a measurement-device-independent (MDI) quantum key distribution (QKD) network of claim 13, comprising the steps of:
receiving, at the user system, optical pulses generated and distributed by a common server;
modulating, at the user system, the optical pulses for quantum communication;
re-transmitting, at the user system, the modulated optical pulses to the common server; and
performing energy bounding, at the user system, for limiting Trojan horse attack (THA).

17. The method of claim 16, wherein performing the energy bounding comprises using a photon number distribution monitoring system, and communicating between user systems for discarding measurement results when the photon number distribution monitoring system determines a non-fulfilment of a bound energy requirement.

18. The method of claim 16, wherein performing the energy bounding comprises using a power limiter for limiting the energy of the re-transmitted modulated optical pulses.
